(19) United States
(12) Patent Application Publication
(10) Pub. No.: US 2026/0220732 A1
(43) Pub. Date: Jul. 30, 2026

(54) IOT LARGE MODEL SYSTEMS AND METHODS FOR EMERGENCY SUPERVISION OF LOW-LYING ROAD SECTIONS

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Rui RU, Chengdu (CN); Yi ZHAO, Chengdu (CN)

(73) Assignee: CHENGDU QINCHUAN IOT TECHNOLOGY CO., LTD., Chengdu (CN)

(21) Appl. No.: 19/463,058

(22) Filed: Jan. 28, 2026

(30) Foreign Application Priority Data
Dec. 31, 2025 (CN) 202512040020.2

(51) Int. Cl. G06Q 50/26; G06Q 50/40; G07C 5/00; G16Y 10/40

(52) U.S. Cl. CPC G06Q 50/265; G06Q 50/40; G07C 5/008; G16Y 10/40

(57) ABSTRACT

Disclosed is an IoT large model system for emergency supervision of low-lying road sections, the system includes an emergency supervision management platform; the emergency supervision management platform is configured to: obtain vehicle operation data of a low-lying area through an emergency supervision object platform; determine waterlogging data based on the vehicle operation data; determine a traffic risk based on the waterlogging data; in response to determining that the traffic risk is greater than a first threshold, determine drainage parameters; determine dispatch parameters based on the drainage parameters; and send, based on the dispatch parameters, a dispatch packet including the drainage parameters to an unmanned vehicle fleet through a heterogeneous communication network, control an unmanned vehicle equipped with a drainage device to travel to the low-lying area, and control a pumping power of the drainage device to be set to a pumping power in the drainage parameters.

### CROSS-REFERENCE TO RELATED APPLICATIONS

This application claims priority to Chinese Application No. 202512040020.2, filed on December 31, 2025, the entire contents of which are incorporated herein by reference.

### TECHNICAL FIELD

The present disclosure generally relates to a field of road monitoring, and in particular to an IoT large model system and a method for emergency supervision of low-lying sections.

### BACKGROUND

During extreme weather events, low-lying road sections in cities are highly susceptible to road waterlogging during heavy rainfall, which not only causes traffic paralysis and vehicle damage but may also trigger secondary disasters such as electric shocks and drowning. Traditional manners primarily rely on manual inspection of road waterlogging and drainage by static drainage facilities. Manual inspection is inefficient and poses a safety risk. Drainage by static drainage facilities cannot reflect the waterlogging distribution across the entire road section and has many limitations in complex city environments. Manual warning information has coarse granularity, neither distinguishing the differences in chassis heights of different vehicle types nor providing real-time waterlogging depth, making it difficult for drivers to determine whether vehicles may pass safely.

Therefore, there is a need for an IoT large model system and a method for emergency supervision of low-lying sections to timely remind of waterlogging situations in low-lying road sections in cities and provide real-time warnings to vehicles and pedestrians, thereby reducing traffic risk.

### SUMMARY

One or more embodiments of the present disclosure provide an Internet of Things (IoT) large model system for emergency supervision of low-lying road sections. The IoT large model system for emergency supervision comprises an emergency supervision user platform, an emergency supervision management platform, and an emergency supervision object platform connected in sequence. The emergency supervision management platform is configured to execute a method for emergency supervision of low-lying sections.

One or more embodiments of the present disclosure provide a method for emergency supervision of low-lying road sections. The method is executed based on the emergency supervision management platform and includes: obtaining vehicle operation data of a low-lying area through an emergency supervision object platform; determining waterlogging data based on the vehicle operation data; determining a traffic risk based on the waterlogging data; in response to determining that the traffic risk is greater than a first threshold, determining drainage parameters; determining dispatch parameters based on the drainage parameters; and sending, based on the dispatch parameters, a dispatch packet including the drainage parameters to an unmanned vehicle fleet through a heterogeneous communication network, controlling an unmanned vehicle equipped with a drainage device to travel to the low-lying area, and controlling a pumping power of the drainage device to be set to the pumping power in the drainage parameters.

One or more embodiments of the present disclosure further provide a non-transitory computer-readable storage medium, wherein the storage medium stores computer instructions, and when a computer reads the computer instructions in the storage medium, the computer executes the method for emergency supervision of low-lying road sections.

Embodiments of the present disclosure can effectively reduce traffic obstruction and accident risk caused by waterlogging, and improve emergency response efficiency of urban low-lying road sections during heavy rainfall.

### BRIEF DESCRIPTION OF THE DRAWINGS

The present disclosure is further described by way of exemplary embodiments. These exemplary embodiments are described in detail with reference to the accompanying drawings. These embodiments are non-limiting. In these embodiments, the same reference numerals denote the same structures.

FIG. 1 is a schematic diagram illustrating a platform structure of an IoT large model system for emergency supervision of low-lying road sections according to some embodiments of the present disclosure.

FIG. 2 is a flowchart illustrating an exemplary process for emergency supervision of low-lying sections according to some embodiments of the present disclosure.

FIG. 3 is a schematic diagram illustrating a waterlogging prediction model according to some embodiments of the present disclosure.

FIG. 4 is a schematic diagram illustrating determining a driving warning and a signal control instruction according to some embodiments of the present disclosure.

### DETAILED DESCRIPTION

The present disclosure uses flowcharts to illustrate operations performed by a system according to embodiments of the present disclosure. It should be understood that preceding or following operations are not necessarily performed precisely in sequence. Conversely, various steps may be processed in reverse order or simultaneously. Meanwhile, other operations may be added to these processes, or one or several operations may be removed from these processes.

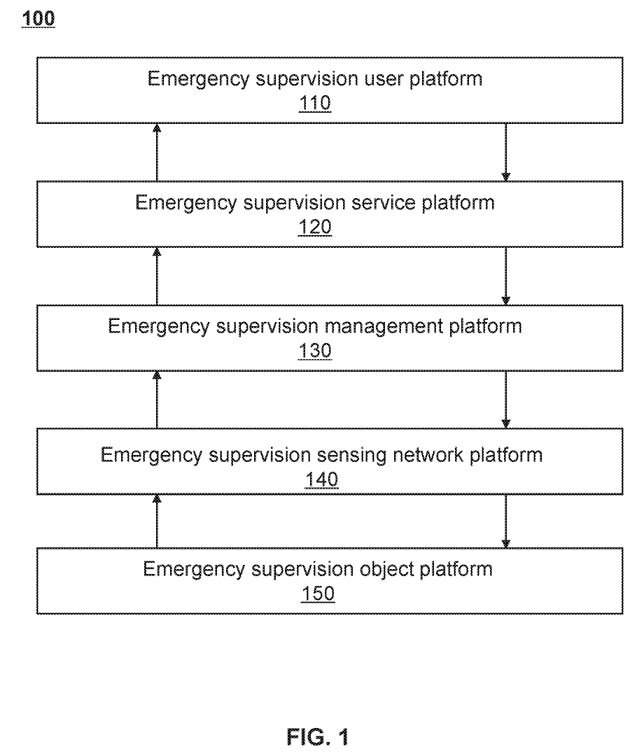

FIG. 1 is a schematic diagram illustrating a platform structure of an Internet of Things (IoT) large model system for emergency supervision of low-lying road sections according to some embodiments of the present disclosure.

In some embodiments, as shown in FIG. 1, the IoT large model system for emergency supervision of low-lying road sections 100 includes an emergency supervision user platform 110, an emergency supervision service platform 120, an emergency supervision management platform 130, an emergency supervision sensing network platform 140, and an emergency supervision object platform 150, which are sequentially connected.

In some embodiments, one or more platforms in the IoT large model system for emergency supervision 100 may exchange information and/or data through a network. In some embodiments, the network may be any one or more of a wired network or a wireless network.

The emergency supervision user platform 110 refers to a platform configured to interact with a user. In some embodiments, the emergency supervision user platform 110 may be configured to provide data visualization and a warning push. The user refers to a superior emergency supervision department or a city citizen.

In some embodiments, the emergency supervision user platform 110 may include a mobile phone, a computer, a mobile terminal, etc.

In some embodiments, the emergency supervision user platform 110 may perform data interaction with the emergency supervision management platform 130. For example, the emergency supervision user platform 110 may receive a driving warning sent by the emergency supervision management platform 130, or the emergency supervision user platform 110 may send a manhole cover distribution to the emergency supervision management platform 130.

In some embodiments, the emergency supervision user platform 110 is configured to obtain a manhole cover distribution and a rainfall.

The emergency supervision service platform 120 refers to a platform configured to convey user instructions and control information. The emergency supervision service platform 120 may perform data interaction with the emergency supervision user platform 110 and the emergency supervision management platform 130. For example, the emergency supervision service platform 120 may receive the manhole cover distribution sent by the emergency supervision user platform 110 and send the manhole cover distribution to the emergency supervision management platform 130.

In some embodiments, the emergency supervision service platform may include an edge computing gateway, a middleware server, a switch, or any combination thereof.

The emergency supervision management platform 130 refers to a platform configured to supervise and manage data related to the IoT large model system for emergency supervision of low-lying road sections 100. The emergency supervision management platform 130 may perform data interaction with the emergency supervision user platform 110 and the emergency supervision sensing network platform 140.

In some embodiments, the emergency supervision management platform 130 may include a processor and a storage device. The processor may include a central processing unit (CPU), an application-specific integrated circuit (ASIC), a microcontroller, or any combination thereof.

In some embodiments, the emergency supervision management platform 130 is configured to: obtain vehicle operation data of a low-lying area through an emergency supervision object platform 150; determine waterlogging data based on the vehicle operation data; determine a traffic risk based on the waterlogging data; in response to determining that the traffic risk is greater than a first threshold, determine drainage parameters; determine dispatch parameters based on the drainage parameters; and send, based on the dispatch parameters, a dispatch packet including the drainage parameters to an unmanned vehicle fleet through a heterogeneous communication network, control an unmanned vehicle equipped with a drainage device to travel to the low-lying area, and control a pumping power of the drainage device to be set to a pumping power in the drainage parameters.

The emergency supervision sensing network platform 140 refers to a functional platform configured for sensing communication. In some embodiments, the emergency supervision sensing network platform 140 may be configured as a communication network, a gateway, etc., and is configured to perform one or more functions of network management, protocol management, command management, and data parsing. For example, the emergency supervision sensing network platform 140 may include a heterogeneous communication network, an edge computing chip, an edge protocol gateway, a network security firewall, or any combination thereof. The heterogeneous communication network refers to a communication network configured to transmit the dispatch packet. The heterogeneous communication network may include a LoRa-WAN heterogeneous communication network.

In some embodiments, the emergency supervision sensing network platform 140 may interact with the emergency supervision management platform 130 and the emergency supervision object platform 150 to implement functions of transmitting the vehicle operation data, the waterlogging data, etc. For example, the emergency supervision sensing network platform 140 may receive the vehicle operation data uploaded by the emergency supervision object platform 150, or send the dispatch packet to the emergency supervision object platform 150.

The emergency supervision object platform 150 refers to a functional platform configured to collect data or execute instructions. In some embodiments, the emergency supervision object platform 150 may include a plurality of devices. The plurality of devices include a vehicle operation data collection device, a drainage device, a vehicle, an unmanned vehicle fleet, a traffic signal device, a warning device, etc.

The vehicle operation data collection device refers to a device configured to obtain the vehicle operation data. For example, the vehicle operation data collection device may include a positioning device (e.g., a Global Positioning System (GPS), a Beidou positioning system, etc.), a speed monitoring device (e.g., a radar speed gun, a vehicle-mounted millimeter-wave radar, etc.), a roadside sensing unit (e.g., a camera, a lidar, a rainfall sensor, etc.), etc. In some embodiments, the positioning device may be configured to obtain a vehicle operation trajectory. The speed monitoring device may be configured to obtain a vehicle speed. The roadside sensing unit may be configured to collect a road traffic flow, a vehicle height distribution, splash data, a rainfall, etc. In some embodiments, the positioning device and the speed monitoring device may be disposed inside the vehicle or on both sides of the road, and the roadside sensing unit may be disposed on both sides of the road.

The drainage device refers to a device configured to drain waterlogging from the low-lying road sections. For example, the drainage device may include a hydraulic drainage device, a vacuum pump, etc.

The vehicle refers to a social vehicle traveling on the road. The vehicle may include a plurality of vehicle types. In some embodiments, different vehicle types correspond to different chassis heights of the vehicles.

The unmanned vehicle fleet refers to a vehicle fleet including a plurality of unmanned vehicles. The unmanned vehicle may be equipped with the drainage device. In some embodiments, the unmanned vehicle fleet may dispatch an unmanned vehicle to perform a drainage task based on the dispatch packet.

The traffic signal device refers to a device on the road configured to indicate vehicle operation. For example, the traffic signal device may include a traffic signal light, an electronic signboard, etc. The electronic signboard may include an LED display, an audible and visual alarm, etc.

The warning device refers to a device configured to push a driving warning to a vehicle. For example, the warning device may include a navigation map (e.g., Baidu Maps, Autonavi Maps, etc.).

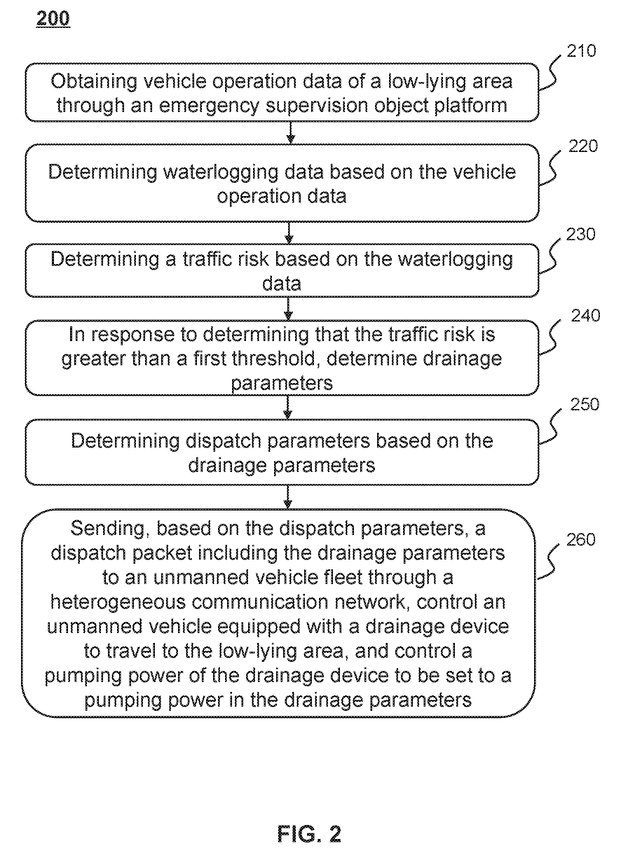

For more content about the above platforms, refer to the descriptions related to FIGS. 2 to 4.

In some embodiments of the present disclosure, the IoT large model system for emergency supervision may form an information operation closed loop between functional platforms, and operate in a coordinated and regular manner under unified management of the emergency supervision management platform, achieving informatization and intelligence of supervision of the low-lying road sections.

It should be noted that the above description of the IoT large model system for emergency supervision 100 is for convenience of description only and cannot limit the present disclosure to the described embodiments.

FIG. 2 is a flowchart illustrating an exemplary process for emergency supervision of low-lying sections according to some embodiments of the present disclosure. As shown in FIG. 2, a process 200 includes step 210 to step 260. In some embodiments, the process 200 is performed by the emergency supervision management platform.

Step 210, obtaining vehicle operation data of a low-lying area through an emergency supervision object platform.

The low-lying area refers to a road that is lower than the surrounding road surface. For example, the low-lying area may include an underpass overpass, a bottom-of-slope road section, a tunnel, etc.

In some embodiments, a boundary of the low-lying area may be a contour of a road that is lower than the surrounding road surface. For example, the boundary may be an outer contour of a tunnel.

In some embodiments, the low-lying area may be preset by the emergency supervision management platform based on a default setting.

The vehicle operation data refers to data related to vehicle operation. In some embodiments, the vehicle operation data may include a vehicle speed, a vehicle operation trajectory, etc.

In some embodiments, the emergency supervision management platform may obtain the vehicle operation data through a vehicle operation data collection device.

For example, the emergency supervision management platform may obtain the vehicle operation trajectory through a GPS positioning system, and obtain the vehicle speed through a vehicle speed sensor.

For more content about the vehicle operation data collection device, refer to the descriptions related to FIG. 1.

Step 220, determining waterlogging data based on the vehicle operation data.

The waterlogging data refers to data related to waterlogging in the low-lying area. In some embodiments, the waterlogging data may include a waterlogging depth.

In some embodiments, the emergency supervision management platform may determine an actual count of vehicles in the low-lying area based on the vehicle operation trajectory, determine a vehicle operation proportion based on the actual count of vehicles in the low-lying area and a count of vehicles upstream and downstream. There are two known situations: the vehicle operation proportion is greater than the proportion threshold, and the vehicle operation proportion is not greater than the proportion threshold. In response to a determination that the vehicle operation proportion is less than or equal to a proportion threshold, determine the waterlogging data based on the vehicle speed by querying a first preset table.

The actual count of vehicles refers to a count of vehicles currently passing through the low-lying road section. In some embodiments, the emergency supervision management platform may determine whether a vehicle passes through the low-lying area based on the vehicle operation trajectory, and determine the actual count of vehicles passing through the low-lying area.

The count of vehicles upstream and downstream refers to a count of vehicles passing through upstream and downstream roads of the low-lying area. In some embodiments, the emergency supervision management platform may determine whether a vehicle passes through the upstream and downstream roads of the low-lying area based on the vehicle operation trajectory, and determine the count of vehicles passing through the upstream and downstream roads of the low-lying area.

In some embodiments, the vehicle operation proportion may be determined by a ratio of the actual count of vehicles to the count of vehicles upstream and downstream.

The proportion threshold refers to a minimum vehicle operation proportion when no waterlogging exists in the low-lying area. In some embodiments, the proportion threshold may be preset by a technician based on experience.

The first preset table may include a relationship between the vehicle speed and the waterlogging depth. The vehicle speed and the waterlogging depth are negatively correlated. In some embodiments, the first preset table may be preset by a technician based on experience.

It should be noted that, in a same time period, a total count of vehicles passing through the low-lying area and upstream and downstream roads of the low-lying area is generally stable. When waterlogging exists in the low-lying area, some vehicles may choose other roads connected to the upstream and downstream roads to pass, and the count of vehicles passing through the low-lying area is less than the count of vehicles passing through the low-lying area when no waterlogging exists.

It should be understood that, if the vehicle operation proportion is less than or equal to the proportion threshold, the emergency supervision management platform may determine that waterlogging currently exists in the low-lying area, and some vehicles choose other roads connected to the upstream and downstream roads to pass. If the vehicle operation proportion is 0, i.e., no vehicle currently passes through the low-lying area, the emergency supervision management platform may determine that the waterlogging data is preset waterlogging data. The preset waterlogging data refers to a maximum waterlogging depth of the low-lying area. In some embodiments, the preset waterlogging data is greater than a largest waterlogging data in the first preset table, and the preset waterlogging data may be preset by a technician based on experience.

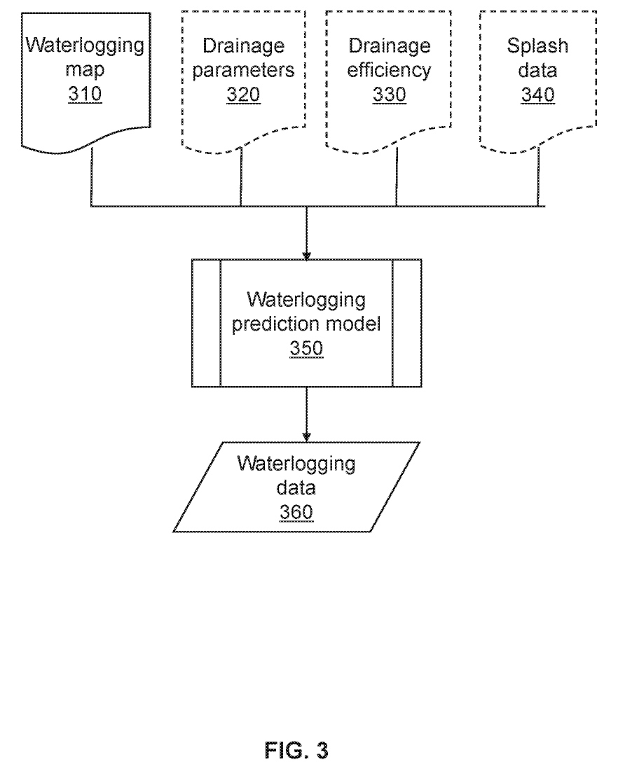

For more content about determining the waterlogging data, refer to the descriptions related to FIG. 3.

Step 230, determining a traffic risk based on the waterlogging data.

The traffic risk refers to a parameter for measuring a safety hazard of road waterlogging in the low-lying area. In some embodiments, the traffic risk may be represented by a numerical value. A greater numerical value indicates a greater traffic risk.

In some embodiments, a processor may determine the traffic risk based on the waterlogging data by querying a second preset table. The second preset table includes a relationship between the waterlogging data and the traffic risk. The waterlogging data and the traffic risk are positively correlated. In some embodiments, the second preset table may be preset by the emergency supervision management platform based on a default setting.

In some embodiments, the emergency supervision management platform may obtain a road traffic flow and a vehicle height distribution within a preset range through the emergency supervision object platform; determine a vehicle operation risk based on the vehicle height distribution and the waterlogging data; determine a road risk based on the road traffic flow within the preset range and the waterlogging data; and determine the traffic risk based on the vehicle operation risk, the road risk, and a current time period.

A preset range refers to a range of an area that includes the low-lying area.

In some embodiments, the preset range has a same shape as the corresponding low-lying area. A boundary of the preset range may be a geometric shape obtained by extending a boundary of the low-lying area outward by a preset distance.

In some embodiments, the preset range is related to a rainfall.

The greater the rainfall, the greater the preset distance by which the boundary of the low-lying area is extended outward, and the greater the preset range. For more content about the preset distance, refer to the related descriptions below.

The rainfall refers to a rainfall within the low-lying area. In some embodiments, the emergency supervision management platform may obtain the rainfall in a plurality of ways. For example, the emergency supervision management platform may directly obtain the rainfall from an external data source (e.g., a local meteorological bureau database). As another example, the emergency supervision management platform may obtain the rainfall by using a rainfall sensor disposed in the low-lying area. For more content about the rainfall sensor, refer to the descriptions related to FIG. 1.

In some embodiments of the present disclosure, the preset range is adjusted based on the rainfall. When the rainfall increases, it is beneficial to cover upstream low-lying areas and potential chain waterlogging areas in advance, avoiding false warnings caused by "monitoring blind spots". When the rainfall decreases, it is beneficial to reduce redundant calculations and communication overhead, improving endurance of edge nodes and bandwidth utilization. This significantly improves emergency response speed and resource support efficiency.

In some embodiments, the emergency supervision management platform may determine the preset range based on the low-lying area and the preset distance.

The preset distance refers to a distance between the boundary of the preset range and the boundary of the low-lying area.

In some embodiments, the emergency supervision management platform may determine the preset distance by querying a third preset table based on the rainfall. The third preset table includes a relationship between the rainfall and the preset distance. The rainfall and the preset distance are positively correlated. The greater the rainfall, the greater the preset distance. In some embodiments, the third preset table may be preset by a technician based on experience.

For example, the emergency supervision management platform may determine a boundary obtained by extending the boundary of the low-lying area outward by the preset distance as the boundary of the preset range.

A road traffic flow refers to a count of vehicles passing on a road within the preset range per unit time.

In some embodiments, the emergency supervision management platform may obtain the road traffic flow by using a vehicle operation data collection device.

For example, the emergency supervision management platform may determine a count of vehicles passing the vehicle operation data collection device per unit time (e.g., 1 minute, 30 minutes) as the road traffic flow.

For more content about the vehicle operation data collection device, refer to the descriptions related to FIG. 1.

A vehicle height distribution refers to a chassis height situation of vehicles within the preset range. A chassis height refers to a distance between a chassis of a vehicle and the ground.

In some embodiments, for each vehicle passing through the low-lying area, the emergency supervision management platform may determine a vehicle type of the vehicle through the emergency supervision object platform, determine the chassis height by querying a type-chassis preset table based on the vehicle type, and determine the vehicle height distribution based on chassis heights of a plurality of vehicles passing through the low-lying area. The type-chassis preset table may include a relationship between the vehicle type and the chassis height. In some embodiments, the type-chassis preset table may be preset by a processor based on a default setting.

For example, for each vehicle passing through the low-lying area, the emergency supervision management platform may obtain a vehicle image of the vehicle passing through the low-lying area by using a roadside sensing unit (e.g., a camera), determine a vehicle type corresponding to the vehicle image by using an image recognition algorithm (e.g., an object detection algorithm) based on the vehicle image, determine the chassis height by querying the type-chassis preset table based on the vehicle type, group a count of vehicles passing through the low-lying area based on the chassis height to determine a count of vehicles corresponding to each chassis height, and determine a plurality of chassis heights and the count of vehicles corresponding thereto as the vehicle height distribution.

A vehicle operation risk refers to a risk that a vehicle will malfunction when passing through the low-lying area. Malfunctions that the vehicle may have include loss of control and skidding, engine stalling, etc. In some embodiments, the vehicle operation risk may be represented by a value. The greater the value, the greater the vehicle operation risk, and the greater the possibility that the vehicle will malfunction when passing through the low-lying area.

In some embodiments, the emergency supervision management platform may determine the vehicle operation risk based on the vehicle height distribution and the waterlogging data.

For example, the emergency supervision management platform may compare the vehicle height distribution and the waterlogging data. If a count of vehicles with chassis heights less than a waterlogging depth in the vehicle height distribution is greater, the vehicle operation risk is greater.

A road risk refers to a risk that waterlogging causes damage to a road. In some embodiments, the road risk may be represented by a value. The greater the value, the greater the road risk, and the greater the possibility that the waterlogging will cause damage to the road.

In some embodiments, there are two known situations: the waterlogging data exceeding a depth threshold and the waterlogging data not exceeding the depth threshold. In response to the waterlogging data exceeding the depth threshold, the emergency supervision management platform may determine the road risk based on the road traffic flow. The depth threshold refers to a maximum waterlogging depth that does not damage the road. In some embodiments, the depth threshold may be preset by a technician based on experience.

In some embodiments, the road traffic flow is positively correlated with the road risk.

A current time period refers to a time period in which a current moment falls. In some embodiments, the emergency supervision management platform may divide daily time into a plurality of time periods based on a traffic situation. The traffic situation refers to a situation where vehicles are concentrated on the road. For example, the emergency supervision management platform may divide the daily time into four time periods: a morning peak time period (07:00-09:00), a daytime off-peak time period (09:01-16:59), an evening peak time period (17:00-19:00), and a nighttime trough time period (19:01-06:59).

In some embodiments, the emergency supervision management platform may determine a traffic risk by performing a weighted summation based on the road risk and the vehicle operation risk. A weight for the weighting may be preset by the emergency supervision management platform based on a default setting.

In some embodiments, a weight of the road risk during the weighting is related to the current time period.

For example, if the current time period is a morning peak time period or an evening peak time period, the emergency supervision management platform may reduce the weight of the road risk to appropriately allow vehicle passage and avoid large-scale traffic congestion caused by road waterlogging.

In some embodiments of the present disclosure, determining the traffic risk based on the vehicle operation risk, the road risk, and the current time period facilitates full consideration of traffic conditions in different time periods, avoids causing large-scale congestion, and provides a relatively comprehensive evaluation basis for subsequent assessment of the traffic risk and the resolution of road problems caused by waterlogging by considering road damage and vehicle passage risk.

In some embodiments, the traffic risk is also related to a risk variation rate.

The risk variation rate refers to a rate of change of the vehicle operation risk.

In some embodiments, the risk variation rate may be determined based on the waterlogging data within a preset time period.

For example, the emergency supervision management platform may determine a waterlogging reduction rate based on the waterlogging data within the preset time period, and determine the risk variation rate based on the waterlogging reduction rate. The waterlogging reduction rate refers to a speed at which a waterlogging depth decreases per unit time.

In some embodiments, an accuracy of the waterlogging reduction rate is positively correlated with a duration of the preset time period.

In some embodiments, the emergency supervision management platform may further determine the traffic risk by performing a weighted summation based on the road risk, the vehicle operation risk, and the risk variation rate. A weight for the weighting may be preset by the emergency supervision management platform based on a default setting.

In some embodiments of the present disclosure, adjusting the traffic risk based on the risk variation rate facilitates a rapid response to emergency drainage when the risk increases rapidly, reduces unnecessary social costs caused by road closures and other regulations when the variation rate decreases or stabilizes, improves warning stability and credibility, and prevents false warnings caused by a single instantaneous peak.

In some embodiments, the traffic risk is also related to an electricity risk.

In some embodiments, the emergency supervision management platform may further determine the traffic risk by performing weighting based on the vehicle operation risk, the road risk, and the electricity risk. A weight for the weighting may be preset by the emergency supervision management platform based on a default setting.

The electricity risk refers to a risk of electric leakage from electrical equipment near the low-lying area during rainfall. The electrical equipment may include a high-voltage electrical box, a traffic signal light, an electronic signboard, or the like.

In some embodiments, the electricity risk is related to an electrical equipment distribution and the waterlogging data.

In some embodiments, the emergency supervision management platform may determine the electricity risk based on the electrical equipment distribution and the waterlogging data. The electrical equipment distribution refers to types of electrical equipment and corresponding quantities thereof within the preset range.

For example, the emergency supervision management platform may determine the electricity risk by matching a preset electricity risk table based on the electrical equipment distribution and the waterlogging data. The preset electricity risk table may include a relationship among the electrical equipment distribution, a waterlogging depth, and the electricity risk. The electrical equipment distribution and the waterlogging depth are positively correlated with the electricity risk. In some embodiments, the preset electricity risk table may be determined by a technician based on historical data.

The historical data may include historical electricity risks, historical waterlogging depth, and historical electrical equipment distribution. In some embodiments, the historical data may be obtained by the technician through actual measurement. For example, the technician may count types of electrical equipment and corresponding quantities thereof within the preset range, manually measure the electricity in the waterlogging, and determine the electricity risk based on experience.

In some embodiments of the present disclosure, considering the relationship between the electricity risk and the traffic risk allows full consideration of safety hazards such as electric shock, enables better assessment of the traffic risk, and reduces the risk of electric shock.

Step 240, in response to determining that the traffic risk is greater than a first threshold, determine drainage parameters.

The first threshold refers to a minimum traffic risk that requires generation of the drainage parameters for drainage.

In some embodiments, the first threshold may be preset by the emergency supervision management platform based on a default.

The drainage parameters refer to parameters for controlling drainage of the drainage device. In some embodiments, the drainage parameters include a drainage device distribution and a pumping power of each drainage device.

The drainage device distribution refers to positions and quantities of drainage devices within the preset range. The pumping power refers to an operating power of the drainage device.

For more content about the drainage device, refer to the descriptions related to FIG. 1.

In some embodiments, there are two known situations: the traffic risk being greater than the first threshold and the traffic risk not being greater than the first threshold. In response to the traffic risk being greater than the first threshold, the emergency supervision management platform may obtain the drainage parameters preset by a technician based on experience from a storage device.

In some embodiments, the emergency supervision management platform may further determine a drainage efficiency based on the waterlogging data, candidate drainage parameters, the traffic risk, and a road traffic flow within the preset range using an efficiency prediction model; and determine the drainage parameters based on the drainage efficiency. For related content regarding the drainage device distribution and the pumping power, refer to the above description.

The candidate drainage parameters refer to parameters that may be used to perform a drainage task.

In some embodiments, the emergency supervision management platform may use the drainage parameters used in a historical drainage process as the candidate drainage parameters based on historical data.

The drainage efficiency refers to a rate at which the drainage device pumps water per unit time. For example, the drainage efficiency may be a volume of water pumped by the drainage device per unit time.

In some embodiments, the emergency supervision management platform may determine the drainage efficiency based on a decrease in the waterlogging depth per unit time.

The efficiency prediction model refers to a model for determining the drainage efficiency. In some embodiments, the efficiency prediction model may be a machine learning model. For example, the efficiency prediction model may be one or a combination of a Graph Neural Network (GNN) model or other custom models.

In some embodiments, an input of the efficiency prediction model may include the waterlogging data, the candidate drainage parameters, the traffic risk, and the road traffic flow within the preset range, and an output may include the drainage efficiency corresponding to the candidate drainage parameters.

In some embodiments, the efficiency prediction model may be obtained by training with a plurality of first training samples having first training labels. A first training sample may include sample waterlogging data, sample drainage parameters, a sample traffic risk, and a sample road traffic flow within the preset range. A first training label corresponding to the first training sample is a sample drainage efficiency of the sample drainage parameters under the condition of the first training sample.

The first training sample may be determined based on historical data. The historical data includes historical waterlogging data, historical drainage parameters, a historical traffic risk, and a historical road traffic flow within a preset range. For each first training sample, a technician may actually measure a decrease speed of a waterlogging depth per unit time, and determine an actual drainage efficiency corresponding to the first training sample in the historical data as the first training label.

In some embodiments, the emergency supervision management platform may perform multi-round iterative training on an initial efficiency prediction model based on the plurality of first training samples with the first training labels, and end the training when an iteration end condition is met, to obtain a trained efficiency prediction model. At least one round of iterative training includes: selecting one or more first training samples from a training dataset; inputting the one or more first training samples into the initial efficiency prediction model to obtain model prediction outputs corresponding to the one or more first training samples; substituting the model prediction outputs corresponding to the one or more first training samples and the first training labels corresponding to the one or more first training samples into a formula of a predefined loss function to determine a value of the loss function; and iteratively updating model parameters in the initial efficiency prediction model based on the value of the loss function until the iteration end condition is met, ending the iteration, and obtaining the trained efficiency prediction model. The model parameters of the initial efficiency prediction model may be iteratively updated in various ways. For example, the update may be performed based on a gradient descent manner. The iteration end condition may include convergence of the loss function, an iteration count reaching a preset count threshold, a loss function value being less than a preset function value threshold, etc.

In some embodiments, one candidate drainage parameter may correspond to one drainage efficiency. The emergency supervision management platform may determine the candidate drainage parameter corresponding to a highest drainage efficiency as the drainage parameter based on a plurality of drainage efficiencies.

It should be noted that directly setting the drainage parameters of all drainage devices to a maximum pumping power may achieve the highest drainage efficiency. However, continuous operation at the maximum pumping power may cause battery/fuel consumption to increase exponentially. In extreme rainstorm scenarios where the unmanned vehicle fleet needs to remain on standby for a long time, a situation may easily occur where pumping is incomplete, but energy is exhausted. Furthermore, when the waterlogging depth decreases to a certain level, the improvement in drainage efficiency from a high pumping power tends to level off, while energy consumption still increases linearly or even quadratically, easily resulting in waste characterized by high energy consumption and low gain.

In some embodiments of the present disclosure, the drainage efficiency is determined based on the waterlogging data, the candidate drainage parameters, the traffic risk, and the road traffic flow within the preset range using the efficiency prediction model, and the drainage parameters is determined based on the drainage efficiency. This process may consider the coordinated operation of a plurality of drainage devices, balance the relationship between pumping efficiency and energy consumption, dynamically determine an optimal deployment coordinate and a power level for each drainage device, adjust the pumping power in real time, avoid excessively low power or waste, improve the drainage efficiency, and reduce a road closure duration.

Step 250, determining dispatch parameters based on the drainage parameters.

The dispatch parameters refer to parameters for dispatching an unmanned vehicle. In some embodiments, the dispatch parameters may include an unmanned vehicle that needs to perform a drainage task, and a position where the unmanned vehicle needs to perform the drainage task.

In some embodiments, the emergency supervision management platform may determine the dispatch parameters based on the low-lying area and the unmanned vehicle fleet.

For example, the emergency supervision management platform may screen unmanned vehicles based on the low-lying area and a preset radius, determine a preset count of unmanned vehicles that are not in a working state and are within the preset radius centered on the low-lying area as the unmanned vehicles that need to be dispatched to the low-lying area. The emergency supervision management platform may determine a specific position to which the unmanned vehicle needs to be dispatched based on a load condition of a drainage pipe network within the low-lying area and the preset radius. It should be understood that if the drainage pipe network within the low-lying area is already at full load, continuing to add the unmanned vehicles to drain water into this drainage pipe network cannot improve the drainage efficiency. The emergency supervision management platform may dispatch the unmanned vehicle to a position near the low-lying area where the drainage pipe network has a smaller load, and drain water from the low-lying area to the drainage pipe network with the smaller load, thereby reducing the load on the drainage pipe network within the low-lying area. The drainage pipe network refers to an underground pipe network in a city used for drainage. The preset range may include a plurality of drainage pipe networks.

As another example, if the count of unmanned vehicles not in a working state within the preset radius centered on the low-lying area does not meet the preset count, the emergency supervision management platform may increase the preset radius until the count of unmanned vehicles not in the working state within the preset radius centered on the low-lying area meets the preset count.

In some embodiments, the emergency supervision management platform may determine the unmanned vehicle that needs to be dispatched to the low-lying area and the position to which the unmanned vehicle is dispatched as the dispatch parameters. The preset radius refers to a preset distance for dispatching the unmanned vehicle. The preset count refers to a preset count of unmanned vehicles to be dispatched. In some embodiments, the preset radius and the preset count may be set by the emergency supervision management platform based on a default setting.

It should be noted that when waterlogging exists in the low-lying area, during an initial stage of the waterlogging, the emergency supervision management platform may only open valves of some conventional drainage outlets (e.g., sewer inlets) or set them to a small opening degree, to avoid an instantaneous huge water flow flushing sediment in the sewer pipe network and causing downstream blockage. Simultaneously, the emergency supervision management platform may dispatch the unmanned vehicles to the low-lying area for active pumping to increase the drainage intensity of the low-lying area. A plurality of unmanned vehicles equipped with drainage devices deployed in one area may be uniformly scheduled by the emergency supervision management platform. For example, the emergency supervision management platform may prioritize turning on the drainage device at the lowest terrain and increasing the pumping power of the drainage device. Alternatively, when a certain drainage pipe network is close to full load, the emergency supervision management platform may temporarily turn off the drainage device at that location and guide the drainage pressure to other pipe networks with smaller loads, achieving dynamic balance and optimization of the drainage load across the entire area.

Step 260, sending, based on the dispatch parameters, a dispatch packet including the drainage parameters to an unmanned vehicle fleet through a heterogeneous communication network, control an unmanned vehicle equipped with a drainage device to travel to the low-lying area, and control a pumping power of the drainage device to be set to a pumping power in the drainage parameters. For more content about the unmanned vehicle fleet, refer to the descriptions related to FIG. 1.

The dispatch packet refers to a data packet for controlling the unmanned vehicle to perform the drainage task. In some embodiments, the dispatch packet may include the drainage parameters and the dispatch parameters.

In some embodiments, the emergency supervision management platform may generate a data packet based on the drainage parameters and the dispatch parameters, and determine the data packet as the dispatch packet.

In some embodiments, the emergency supervision management platform may send the dispatch packet to the unmanned vehicle fleet through the heterogeneous communication network, determine the unmanned vehicle that needs to be dispatched based on the dispatch packet, and control the unmanned vehicle that needs to be dispatched to travel to the low-lying area.

In some embodiments, the emergency supervision management platform may send the dispatch packet to the unmanned vehicle fleet through the heterogeneous communication network, adjust the pumping power of the drainage device on the unmanned vehicle based on the drainage parameters in the dispatch packet, and control the drainage device to perform drainage on the low-lying area based on the pumping power.

In some embodiments of the present disclosure, the waterlogging data is determined based on the vehicle operation data; subsequently, the traffic risk is determined; the drainage parameters and the dispatch parameters are determined; and the dispatch packet is sent to the unmanned vehicle fleet through the heterogeneous communication network based on the dispatch parameters, and the unmanned vehicle is controlled to move to the low-lying area for drainage. This is beneficial for reducing the risk for vehicles and pedestrians passing through the low-lying area, avoiding the risk of pedestrians or vehicles accidentally falling in due to constantly opening drainage outlets, reducing blockage of the drainage system by daily garbage, lowering maintenance costs and the risk of blockage during the rainy season, effectively isolating the overflow of foul odors and the breeding of mosquitoes, achieving on-demand drainage, and effectively maximizing the role of the drainage device.

It should be noted that the above description of process 200 is merely for illustration and explanation, and does not limit the applicable scope of the present disclosure. Those skilled in the art may make various modifications and changes to process 200 under the guidance of the present disclosure. However, these modifications and changes still fall within the scope of the present disclosure.

FIG. 3 is a schematic diagram illustrating a waterlogging prediction model according to some embodiments of the present disclosure.

In some embodiments, the emergency supervision management platform may obtain a manhole cover distribution and a rainfall through the emergency supervision user platform, construct a waterlogging map 310 based on the vehicle operation data, the rainfall, and the manhole cover distribution; and predict the waterlogging data 360 by inputting the waterlogging map 310 into the waterlogging prediction model 350.

For more content about the rainfall and the vehicle operation data, refer to the descriptions related to FIG. 2.

The manhole cover distribution refers to positions and quantity of manhole covers within a preset range.

In some embodiments, the emergency supervision management platform may obtain the manhole cover distribution through the emergency supervision user platform.

For example, a user may directly input the manhole cover distribution through the emergency supervision user platform.

As another example, the emergency supervision management platform may obtain the manhole cover distribution from a storage device.

For more content about the rainfall, refer to the descriptions related to FIG. 2.

The waterlogging map may be a directed graph including nodes and edges. In some embodiments, the waterlogging map includes a plurality of nodes, and an edge exists between any two nodes. An edge of the waterlogging map may be directed from a node at a higher altitude to a node at a lower altitude.

The nodes may include a first type of node and a second type of node.

The first type of node refers to the low-lying area. In some embodiments, the node features of the first type of node include a size of the low-lying area, a location of the low-lying area, the rainfall, and the vehicle operation data.

In some embodiments, a waterlogging map includes one node of the first type.

The second type of node refers to a manhole cover. In some embodiments, the node features of the second type of node include a location of the manhole cover and a size of the manhole cover.

An edge is used to connect any two nodes. In some embodiments, the edge features of the edge may include a distance between the two nodes at the ends of the edge and an altitude difference.

In some embodiments, the emergency supervision management platform may construct the waterlogging map based on the vehicle operation data, the rainfall, and the manhole cover distribution.

The waterlogging prediction model refers to a model used to determine the waterlogging data. In some embodiments, the waterlogging prediction model may be a machine learning model. As an example, the waterlogging prediction model may be a Graph Neural Network (GNN) model, another custom model, or a combination of one or more thereof.

In some embodiments, the input of the waterlogging prediction model may include the waterlogging map, and the output may include the waterlogging data of the first type of node.

In some embodiments, the waterlogging prediction model may be obtained by training with a large count of second training samples with second training labels. The second training sample may include a sample waterlogging map. The second training label corresponding to the second training sample is sample waterlogging data.

The second training sample may be determined based on historical data. The historical data includes historical waterlogging data, historical drainage parameters, a historical traffic risk, and a historical road traffic flow within a preset range. For each second training sample, a technician may use a water level sensor (e.g., a radar water level gauge, a pressure water level gauge, an ultrasonic water level gauge, etc.) to actually measure the waterlogging depth of the first type of node under the condition of the second training sample, and determine the actual waterlogging depth of the first type of node corresponding to the second training sample as the second training label.

In some embodiments, the training of the waterlogging prediction model is similar to the training of the efficiency prediction model. For the training of the efficiency prediction model, refer to the descriptions related to FIG. 2.

In some embodiments, the input of the waterlogging prediction model further includes drainage parameters 320 of the drainage device, drainage efficiency 330, and splash data 340.

The splash data refers to data on the splash pattern formed when wheels of a vehicle splash the accumulated water. For example, the splash data may include a splash size, a splash shape, etc.

In some embodiments, the emergency supervision management platform may obtain the splash data through the emergency supervision object platform.

For example, the emergency supervision management platform may use a camera to obtain the splash data of the water splashed by the wheels when a vehicle passes through the low-lying area. For more content about the camera, refer to the descriptions related to FIG. 1.

In some embodiments, the second training sample may further include sample drainage parameters of the drainage device, a sample drainage efficiency, and sample splash data.

In some embodiments of the present disclosure, considering the drainage parameters of the drainage device, the drainage efficiency, and the splash data may make the determined waterlogging data more closely reflect the actual situation.

In some embodiments of the present disclosure, by considering the factor of rainfall filling the low-lying area, fully considering the drainage effect of manhole covers in the low-lying area, and simultaneously constructing the waterlogging map to consider the entire spatial structure, the determined waterlogging data may be made to more closely reflect the actual situation. Determining the waterlogging data through the waterlogging prediction model can reduce prediction errors and improve prediction effectiveness.

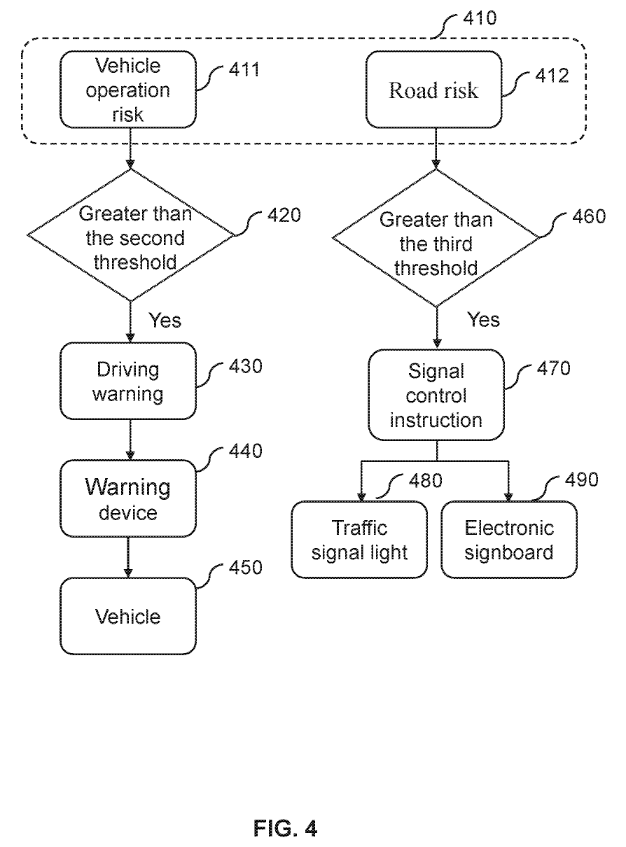

FIG. 4 is a schematic diagram illustrating determining a driving warning and a signal control instruction according to some embodiments of the present disclosure.

In some embodiments, it is known that vehicle operation risk 411 has two cases: the vehicle operation risk being greater than the second threshold 420 and the vehicle operation risk not greater than the second threshold 420, and road risk 412 has two cases: the road risk being greater than the third threshold 460 and the road risk not greater than the third threshold 460. In response to determining that the vehicle operation risk 411 is greater than the second threshold 420, the emergency supervision management platform may determine a driving warning 430 and push the driving warning 430 to a plurality of vehicles 450 through a warning device 440. And, in response to the road risk 412 being greater than the third threshold 460, the emergency supervision management platform may generate a signal control instruction 470.

For more content about the warning device, refer to the descriptions related to FIG. 1.

The second threshold refers to a minimum vehicle operation risk for determining the driving warning.

In some embodiments, the second threshold may be preset by the emergency supervision management platform based on a default setting.

The driving warning refers to warning information sent to a vehicle. For example, the driving warning may include a warning icon on a navigation map, etc.

In some embodiments, the driving warning may be preset by the emergency supervision management platform based on a default setting.

For example, the emergency supervision management platform may preset the driving warning when the vehicle operation risk in each low-lying area is high.

In some embodiments, there are two known situations: the vehicle operation risk is greater than the second threshold and not greater than the second threshold. In response to a determination that the vehicle operation risk is greater than the second threshold, the emergency supervision management platform may send the driving warning to the vehicle in real time through the warning device. For example, in response to a determination that the vehicle operation risk of the low-lying area is greater than the second threshold, the emergency supervision management platform may send the preset driving warning for that low-lying area to the vehicle through the warning device.

The third threshold refers to a minimum road risk for generating a signal control instruction.

In some embodiments, the first threshold is less than the second threshold, and the second threshold is less than the third threshold.

In some embodiments, the third threshold may be preset by the emergency supervision management platform based on a default setting.

The signal control instruction refers to an instruction used to control a traffic signal device to display warning information.

In some embodiments, the signal control instruction 470 may be configured to control a plurality of traffic signal lights 480 to display a preset color during a preset period, and/or control an electronic signboard 490 to display preset content during the preset period.

For example, if the road risk is high during a current time period, the emergency supervision management platform may send the signal control instruction to the traffic signal light to control the traffic signal light to turn red, and/or send the signal control instruction to the electronic signboard to control the electronic signboard to display "Waterlogging, No Entry".

For more content about the traffic signal device, refer to the descriptions related to FIG. 1.

In some embodiments, the emergency supervision management platform may generate the signal control instruction based on the road risk.

In some embodiments of the present disclosure, by pushing the driving warning to a plurality of vehicles through the warning device and generating the signal control instruction, vehicles can be warned in advance, the incidence of vehicle accidents can be reduced, congestion in low-lying areas can be decreased, and traffic efficiency and safety redundancy can be ensured.

One or more embodiments of the present disclosure provide a non-transitory computer-readable storage medium. The storage medium stores computer instructions, and when a computer reads the computer instructions in the storage medium, the computer executes the method for emergency supervision of low-lying sections.

The basic concepts have been described above. Obviously, to those skilled in the art, the above detailed disclosure is merely an example and does not constitute a limitation on the present disclosure. Although not explicitly stated herein, those skilled in the art may make various modifications, improvements, and corrections to the present disclosure. Such modifications, improvements, and corrections are suggested in the present disclosure, and therefore still fall within the spirit and scope of the exemplary embodiments of the present disclosure.

What is claimed is:

1. An Internet of Things (IoT) large model system for emergency supervision of low-lying road sections, wherein the IoT large model system comprises an emergency supervision management platform;
the emergency supervision management platform is configured to:
obtain vehicle operation data of a low-lying area through an emergency supervision object platform;
determine waterlogging data based on the vehicle operation data;
determine a traffic risk based on the waterlogging data;
in response to determining that the traffic risk is greater than a first threshold, determine drainage parameters;
determine dispatch parameters based on the drainage parameters; and
send, based on the dispatch parameters, a dispatch packet including the drainage parameters to an unmanned vehicle fleet through a heterogeneous communication network, control an unmanned vehicle equipped with a drainage device to travel to the low-lying area, and control a pumping power of the drainage device to be set to a pumping power in the drainage parameters.

2. The IoT large model system according to claim 1, wherein the emergency supervision management platform is further configured to:
obtain a manhole cover distribution and a rainfall through an emergency supervision user platform;
construct a waterlogging map based on the vehicle operation data, the rainfall, and the manhole cover distribution; and
predict the waterlogging data based on the waterlogging map using a waterlogging prediction model, wherein the waterlogging prediction model is a machine learning model.

3. The IoT large model system according to claim 2, wherein an input of the waterlogging prediction model further includes the drainage parameters of the drainage device, a drainage efficiency, and splash data.

4. The IoT large model system according to claim 1, wherein the emergency supervision management platform is further configured to:
obtain a road traffic flow and a vehicle height distribution within a preset range through the emergency supervision object platform;
determine a vehicle operation risk based on the vehicle height distribution and the waterlogging data;
determine a road risk based on the road traffic flow within the preset range and the waterlogging data; and
determine the traffic risk based on the vehicle operation risk, the road risk, and a current time period.

5. The IoT large model system according to claim 4, wherein the traffic risk is further related to a risk variation rate, and the risk variation rate is determined based on the waterlogging data within a preset time period.

6. The IoT large model system according to claim 4, wherein the traffic risk is further related to an electricity risk, and the electricity risk is related to an electrical equipment distribution and the waterlogging data.

7. The IoT large model system according to claim 4, wherein the emergency supervision management platform is further configured to:
in response to determining that the vehicle operation risk is greater than a second threshold, determine a driving warning, and push the driving warning to a plurality of vehicles through a warning device;
in response to determining that the road risk is greater than a third threshold, generate a signal control instruction, wherein the signal control instruction is configured to control a plurality of traffic signal lights to display a preset color during a preset period and/or an electronic signboard to display a preset content during the preset period.

8. The IoT large model system according to claim 1, wherein the drainage parameters include a drainage device distribution and a pumping power of each drainage device, and the emergency supervision management platform is further configured to:
determine a drainage efficiency based on the waterlogging data, candidate drainage parameters, the traffic risk, and a road traffic flow within a preset range using an efficiency prediction model; and
determine the drainage parameters based on the drainage efficiency.

9. The IoT large model system according to claim 4, wherein the preset range is related to a rainfall.

10. A method for emergency supervision of low-lying sections, wherein the method is executed based on an emergency supervision management platform and comprises:
obtaining vehicle operation data of a low-lying area through an emergency supervision object platform;
determining waterlogging data based on the vehicle operation data;
determining a traffic risk based on the waterlogging data;
in response to determining that the traffic risk is greater than a first threshold, determining drainage parameters;
determining dispatch parameters based on the drainage parameters; and
sending, based on the dispatch parameters, a dispatch packet including the drainage parameters to an unmanned vehicle fleet through a heterogeneous communication network, controlling an unmanned vehicle equipped with a drainage device to travel to the low-lying area, and controlling a pumping power of the drainage device to be set to the pumping power in the drainage parameters.

11. The method according to claim 10, wherein the determining waterlogging data based on the vehicle operation data includes:
obtaining a manhole cover distribution and a rainfall through an emergency supervision user platform;
constructing a waterlogging map based on the vehicle operation data, the rainfall, and the manhole cover distribution; and
predicting the waterlogging data based on the waterlogging map using a waterlogging prediction model, wherein the waterlogging prediction model is a machine learning model.

12. The method according to claim 11, wherein an input of the waterlogging prediction model further includes the drainage parameters of the drainage device, a drainage efficiency, and splash data.

13. The method according to claim 10, wherein the determining a traffic risk based on the waterlogging data includes:
obtaining a road traffic flow and a vehicle height distribution within a preset range through the emergency supervision object platform;
determining a vehicle operation risk based on the vehicle height distribution and the waterlogging data;
determining a road risk based on the road traffic flow within the preset range and the waterlogging data; and
determining the traffic risk based on the vehicle operation risk, the road risk, and a current time period.

14. The method according to claim 13, wherein the traffic risk is further related to a risk variation rate, and the risk variation rate is determined based on the waterlogging data within a preset time period.

15. The method according to claim 13, wherein the traffic risk is further related to an electricity risk, and the electricity risk is related to an electrical equipment distribution and the waterlogging data.

16. The method according to claim 13, wherein the method further comprises:
in response to determining that the vehicle operation risk is greater than a second threshold, determining a driving warning, and pushing the driving warning to a plurality of vehicles through a warning device; and
in response to determining that the road risk is greater than a third threshold, generating a signal control instruction, wherein the signal control instruction is configured to control a plurality of traffic signal lights to display a preset color during a preset period and/or an electronic signboard to display a preset content during the preset period.

17. The method according to claim 10, wherein the drainage parameters include a drainage device distribution and a pumping power of each drainage device, and the in response to determining that the traffic risk is greater than a first threshold, determining drainage parameters includes:
determining a drainage efficiency based on the waterlogging data, candidate drainage parameters, the traffic risk, and a road traffic flow within a preset range using an efficiency prediction model; and
determining the drainage parameters based on the drainage efficiency.

18. The method according to claim 13, wherein the preset range is related to a rainfall.

19. A non-transitory computer-readable storage medium, wherein the storage medium stores computer instructions, and when a computer reads the computer instructions in the storage medium, the computer executes the method according to claim 10.
